(19) United States
(12) Patent Application Publication
(10) Pub. No.: US 2025/0388393 A1
(43) Pub. Date: Dec. 25, 2025

(54) Plastic Reducing Trash Receptacle

(71) Applicant: Keith Hunt Allen, Palmer lake, CO (US)

(72) Inventor: Keith Hunt Allen, Palmer lake, CO (US)

(21) Appl. No.: 18/748,725

(22) Filed: Jun. 20, 2024

(51) Int. Cl. B65F 1/06; B65B 67/12

(52) U.S. Cl. CPC B65F 1/06; B65B 67/1227; B65B 67/1233

(57) ABSTRACT

A trash can/receptacle purposefully designed to re-use and repurpose single-use, heavy gauge/robust, non-standard plastic bags from other areas of economic activity. The trash can/receptacle adapts to different sized non-standard bags by providing a flexible bag clamping clasp, variable bag height adapters and posts under tension that serve to hold the bag upright and open for easy trash ingress. Non-standard plastic bags are bags of various sizes and construction from other lines of economic activity that are not normally associated with trash receptacle liners and normally discarded because of their difficulty in being repurposed. The purpose built trash receptacle reduces the manufacture of virgin plastic trash receptacle liners by obviating their necessity by supplanting with previously used bags thereby reducing the propensity of plastic in the environment which can be harmful to life.

### FIELD OF THE INVENTION

The present invention relates to trash cans/receptacles, specifically trash cans/receptacles that reduce the consumption of plastic.

### DESCRIPTION OF THE RELATED ART

The present invention relates to the field of trash cans/receptacles. State of the art trash cans/receptacles, large and small follow a strategy of a tough outer shell and a pliable and flexible inner liner. The inner liners are almost always virgin single-use plastic; hereafter plastic liners, plastic bags or just bags. The tough outer shell is what the public thinks of when discussing trash cans/receptacles so hereafter will refer to the tough outer shell as trash can.

The plastic liners come in direct contact with refuse. Without the plastic liner, the trash can may be soiled and over time become odoriferous and unsanitary thus the plastic liner is considered essential. When full, the plastic liners are closed via draw string, twist tie or other mechanism and removed from the trash can and discarded into larger receptacles where they enter the public waste stream and eventually are placed in a landfill or incinerated or, without proper disposal, become litter. Another virgin single-use plastic liner is then used and the process repeats.

The trash can provides protection of the plastic liner and also provides upright support for the plastic liner and even aesthetic qualities. The plastic liner provides easy sanitary disposal when full. The manufacturers of the trash can be different from the manufacturers of the plastic liner; each pays little heed to the other except to confirm that there is a bag to fit the trash can and a trash can for the bag.

Plastic liners found in trash cans at homes and businesses typically are made of virgin polyethylene pellets that are, through blown film extrusion, made into rolls of bags. They are extremely thin; 0.7-0.9 mils and inexpensive. Because of the thin nature of the bags, puncture and spillage of contents is common often leading to waste escaping into and polluting the environment. Not only are litter pick-up crews a societal cost but it is one way plastic enters the environment permanently and causes harm to human and non-human life.

Many bags that are, through one mechanism or another, outside of the disposal stream end up in the ocean and environment where they pose a significant hazard to wildlife and aquatic species in addition to human health through ingestion of micro-plastics. The plastic liners, like 50% of all plastic created today, are single-use helping to explain the propensity of harmful plastic found in the world today.

To humans and non-humans alike, the negative health affects of chemicals found in and emanating from plastic is well researched and documented. Chemicals that include biphenols and phthalates are proven endocrine disruptors that can, among other things, lead to increased cancer rates and lowered sperm counts in men.

Additionally, plastic is a petroleum product and is contributing CO2 (carbon dioxide) directly into the atmosphere when burned in or outside of incinerators and contributes CO2 indirectly through petroleum extraction and manufacturing processes.

Many trash cans, in addition to the liners, consist of virgin plastic in their entirety or as a large percentage of their construction. Recycling is the process of remelting and reusing plastic to form new products. Usually, the recycled plastic is mixed with virgin plastic because the structural properties of the plastic are degraded during the recycling and the remelting process. Typically, plastic is only recycled one time with recycling rarely exceeding two times. Only 9% of all plastic is recycled. Because of this, “end of life” for a plastic trash can usually does not include recycling thus the waste disposal industry is contributing to the problem of excess plastic.

In alternate areas of economic activity, large robust non-standard (sized) plastic bags are produced in massive quantities to hold goods as disparate as gardening soil, mulch, dog food, compost, agricultural feed, salt pellets, dried beans and rice etc. These bags, because manufacturers are averse to loss of profits when bags break, are usually an order of magnitude thicker and much more robust than the plastic liners made for trash cans. These bags however are not optimized for re-use nor are they of standard size and shape; they are single-use by design and are normally discarded after their contents are used.

Therefore, what is needed are techniques, mechanisms and solutions that allow plentiful, robust bags in alternate areas of economic activity to replace and supplant thin, virgin, prone-to-breaking bags in the waste handling economy. Bringing surplus and need together to replace problematic plastic liners currently in use would reduce plastic need and consumption thereby ameliorating the above mentioned disadvantages of plastic like; single-use, limited recyclability, harmful chemical exposure per unit of plastic, plastic escaping into the environment and CO2 emissions from plastic. Generally, it is now considered essential for human, non-human and planetary health to reduce plastic use by any and all means necessary.

### SUMMARY OF THE INVENTION

The present invention has been developed in response to the present state of the art, and in particular, in response to the problems and needs in the art that have not yet been fully solved by currently available trash cans and plastic liners. Accordingly, the present invention has been developed to reduce the need for plastic, reduce plastic consumption and reduce the content of plastic in trash cans.

In one embodiment of the invention, a trash can may comprise: a heavy metal base for ballast and stability; a plurality of vertical or near vertical metal posts circumferentially positioned, possibly of varying lengths, emanating upward from said base to support robust bags from alternate areas of economic activity, in an upright orientation with the opening facing skyward for easy trash ingress; bags clasps atop a plurality of said metal posts firmly grip said robust plastic bags.

In one embodiment of the invention, said metal posts may be tilted slightly outward to tension and spread open an attached bag thus maintaining and maximizing an open posture and profile to ease trash ingress.

In one embodiment, cork or similar soft material feet may be attached to the bottom of said base to provide a non-sliding quality and/or to provide non-marring floor contact.

In one embodiment said bag clasps contain a metal protrusion capable of piercing the plastic bag to hook into and anchor the plastic bag to the bag clasp.

In one embodiment said bag clasps contain a spring or similar mechanism that pinches the bag between two metal parts for a vise-like holding quality. Such a spring would apply constant bag holding pressure.

In one embodiment said metal posts are able to accept post extenders to increase the length of the posts thus accommodating different height and different volume non-standard bags from alternate areas of economic activity.

In one embodiment said metal base contains alternate connection points for a plurality of metal posts thus accommodating different width/depth and different volume non-standard bags from alternate areas of economic activity.

In one embodiment said metal bag clasps contain a full or partial rim for the non-standard bag to be draped over, as with a cuff, thus providing a more secure grip of the bag.

In one embodiment said metal bag clasps are removable to aid in removing full bags and to ease insertion and placement of new bags.

In one embodiment of the invention, optional aesthetic panels, including a cover, may mount to said metal posts or base for aesthetic appeal.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates one embodiment of the present invention without a non-standard heavy gauge (robust) single-use bag from an alternate area of economic activity.

FIG. 2 illustrates one embodiment of the present invention with a non-standard heavy gauge single-use bag from an alternate line of economic activity.

FIG. 3 illustrates how different embodiments and configurations can extend the usefulness of the trash can and illustrate adaptation to different non-standard sized bags.

FIG. 4 illustrates one embodiment of the slide-on, slide-off removable bag clasp

FIG. 5 illustrates one embodiment of the bag clasp mechanism in the clamped position and containing a metal protrusion capable of piercing a plastic bag.

FIG. 6 illustrates one embodiment of the bag clasp mechanism in the open position needed for installing a new bag or removing a full bag.

FIG. 7 illustrates a cut-away of a bag draped over the bag clasp and held securely in place.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

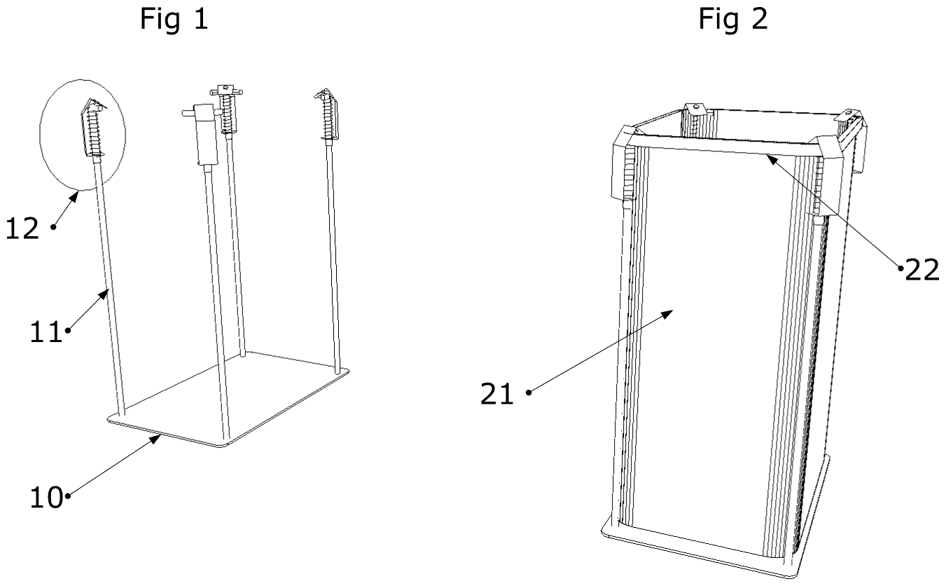

FIG. 1 details the preferred embodiment of the trash can. It consists of a heavy metal base (10) or similar material that acts as ballast to stabilize the trash can. Four metal rods (11) with springiness, and circumferentially positioned are secured to and emanate vertically or nearly vertically from the base (10). The springiness of the rods (11) keeps tension on the bag (FIG. 2, 21) opening as the rods (11) are slightly deformed inwards towards the center of the bag (FIG. 2, 21) when clasping the bag (FIG. 2, 21). The height of the rods (11) roughly determines what length/height bags (FIG. 2, 21) can be utilized or where the trash can may be placed, for example under a kitchen sink cabinet. The spacing between the rods (11) allows the bags (FIG. 2, 21) to expand and protrude past the rods (11) as the bags (FIG. 2, 21) fill up with trash, allowing different non-standard bags (FIG. 2, 21) with different footprints and volumes to be used. Removable bag clasp (12) assemblies at the top of each rod (11) hold the bags (FIG. 2, 21) firmly in place such that refuse can be compacted without dislodging the bag (FIG. 2 21) from the bag clasp (12). Removability of the bag clasps (12) allows ease of removal of the bag (FIG. 2, 21) when full and allows easy insertion and securing of a new bag (FIG. 2, 21) because with the bag clasp (12) removed, there is nothing for the bag (FIG. 2, 21) to snag or catch on.

FIG. 2 details one embodiment of the trash can with a bag (21) inserted. The opening of the bag is draped around the rim pieces (FIG. 5, 51) and clamped. A cuff (22) is made in the bag (21) to aid in positioning the bag (21) over the rim piece (FIG. 5, 51) and to aid in gripping the bag (21).

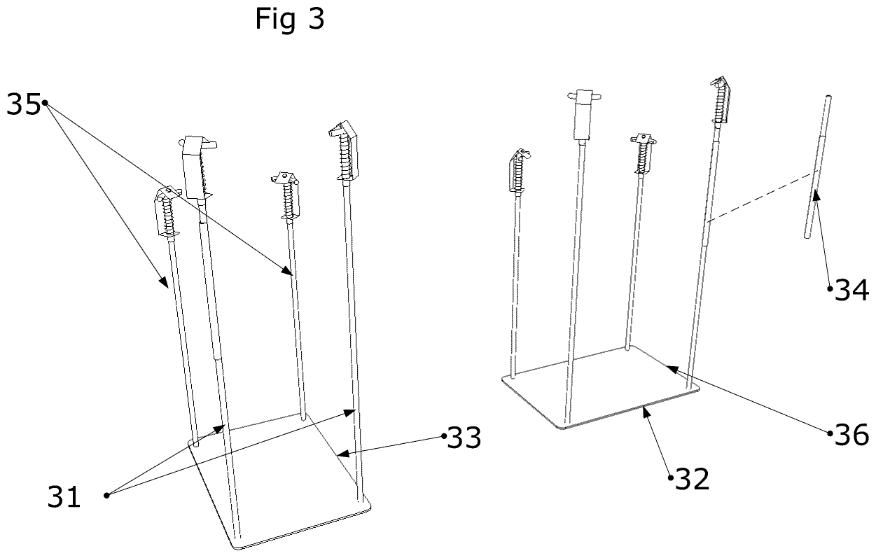

FIG. 3 shows how different length rods (FIG. 1, 11) can be mixed and matched both in size and axis placement to extend the uses of the trash can. Short rods (35) combined with long rods (31) can accommodate placement in constrained spaces such as under a kitchen sink: the end with the lower rods (35) in this embodiment, allows for easy trash ingress when a kitchen sink cabinet door is open; the end with longer rods (31) may extend to just below the kitchen sink cabinet door height. Different length rods (FIG. 1, 11) can be placed on the short axis (36) or the long axis (32) of the base (FIG. 1, 10) to provide different access profiles (ie narrow or wide end facing out).

Changing the height of the rods (FIG. 1, 11) with adapters/extenders (34) as shown in this embodiment, allows accommodation of different height and volume bags (FIG. 2, 21). For example, a common 1 cubic ft garden soil bag is approximately 24″ long whereas a common 2 cubic ft garden soil bag is approximately 34″.

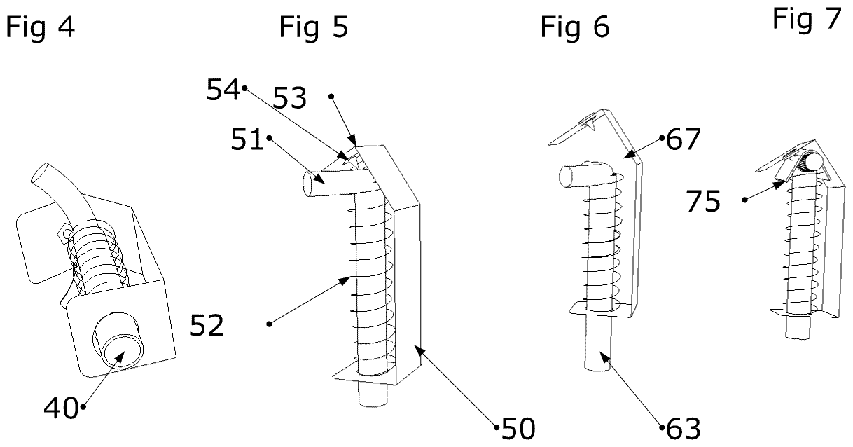

FIG. 4 illustrates the removable nature of the bag clasp (FIG. 1, 12) in this embodiment by being hollow (40) to slide-on and slide-off the rods (FIG. 1, 11). Removal of the clasp (FIG. 1, 12) from the support rod (FIG. 1, 11) aids removal of full trash bags (FIG. 2, 21) and insertion of new bags (FIG. 2, 21).

FIG. 5 depicts a close up of the spring (52) loaded bag clasp (FIG. 1, 12) in the clamped position without a bag (FIG. 2, 21). The spring (52) is constrained on the top by the bag rim piece (51) and thus pushes the sliding clamp (50) down providing constant downward clamping pressure at the clamping point (53) against the bag rim piece (51). This is analogous to a vise with the stationary jaw being the rim piece (51) and the movable jaw being the sliding clamp (50).

The piercer (54) can slightly puncture and hook non-standard plastic bags (FIG. 2, 21) making a secure anchor much like a tent stake keeps a pitched tent in one place. This allows trash to be compacted without the bag (FIG. 2, 21) slipping or disengaging from the bag clasp (FIG. 2, 12).

FIG. 6 depicts a close up of the the bag clasp (FIG. 1, 12) in the open position for removal of a bag (FIG. 2, 21) or insertion of a new bag (FIG. 2, 21). The sliding clamp (FIG. 5, 50), with the help of human fingers to depress the spring (FIG. 5, 52), is able to slide up to release and down on the hollow shaft (63) to clamp. When lifted via human hand and fingers, the piercer (FIG. 5, 54) on the sliding clamp (FIG. 5, 50), is lifted from the bag (FIG. 2, 21) releasing the anchor allowing a bag (FIG. 2,21) to be freely removed or inserted.

FIG. 7 depicts a close up and partial cut-away view of the bag clasp (FIG. 1, 12) in the clamped position with the relevant portion of a bag (75) shown. The clamping action that holds the bag (75) firmly in place is achieved by either stretching or draping (or both) the plastic bag end (75) over the top of the rim piece (FIG. 5, 51) when open (FIG. 6), then, releasing the sliding clamp (FIG. 5, 50) and consequently, with the applied pressure from above by the clamp body (FIG. 5, 50) at the clamp point (FIG. 5, 53) by means of the spring (FIG. 5, 52) that together act like a vise to hold the bag (75) securely in place. The piercer (FIG. 5, 54), a pointed machine screw in this embodiment, pierces the plastic bag (75) thus anchoring the bag (75) to keep it from sliding or dislodging during compaction. Space (FIG. 6, 67) between the clamp body (FIG. 5, 50) and the compression spring (FIG. 5, 52) provide sufficient space for the bag end (75) when it is draped over the top of the rim piece (FIG. 5, 51). The compression spring (52) is of sufficient strength to maintain grip on the bag (75) yet be operated by human hands and fingers.

What is claimed is:

1. A trash can/receptacle comprising:
a. a heavy base;
b. a plurality of vertical or near vertical posts, circumferentially positioned, emanating upward from the base; and
c. a plurality of bag clasps attached atop said posts.

2. The trash can/receptacle of claim 1, further comprising:
a. Non-sliding, non-marring feet attached to bottom of base.

3. The trash can/receptacle of claim 1, further comprising:
a. a plastic bag piercer or metal protrusion within the bag clasp; and
b. a vise functionality spring within the bag clasp; and
c. rim piece/vise stationary jaw; and
d. sliding clamp/vise movable jaw.

4. The trash can/receptacle of claim 1, further comprising:
a. post extenders/adapters; and
b. differing post lengths; and
c. post connection point alternative spacing on base.
